(19) United States
(12) Patent Application Publication
(10) Pub. No.: US 2017/0347826 A1
(43) Pub. Date: Dec. 7, 2017

(54) DEVICE FOR BREWING A BEVERAGE

(71) Applicant: Conopco, Inc., d/b/a UNILEVER, Englewood Cliffs, NJ (US)

(72) Inventors: Cristian Simion POPA, Royston (GB); Robert David TOLFTS, London (GB); Grant WEST, East Hyde (GB)

(73) Assignee: Conopco, Inc., d/b/a UNILEVER, Englewood Cliffs, NJ (US)

(21) Appl. No.: 15/527,461

(22) PCT Filed: Oct. 22, 2015
(86) PCT No.: PCT/EP2015/074547

§ 371 Date: May 17, 2017

(30) Foreign Application Priority Data
Nov. 21, 2014 (EP) 14194235.9

(51) Int. Cl. A47J 31/06; A47J 31/46; A23F 3/18; A47J 31/40; A47J 31/54; B65D 85/804

(52) U.S. Cl. CPC A47J 31/0642; A47J 31/407; A47J 31/542; A47J 31/46; A23F 3/18; A47J 31/0615; A47J 31/0605; B65D 85/8043

(57) ABSTRACT

A brewing device, the device comprising; a reservoir for containing a supply of liquid, and a channel providing a flow channel from the reservoir to a rinse head situated in an infusion chamber, wherein the rinse head is mounted to be rotatable, defining an axis of rotation, the rinse head comprising at least one arcuate rinse channel, arranged to project rinse water with momentum in a direction that provides a moment about the axis of rotation; and a brewing device, the device comprising; a reservoir for containing a supply of liquid, and a channel providing a flow channel from the reservoir to a rinse head situated in an infusion chamber and comprising a plurality of rinse channels, wherein the rinse head is mounted to be rotatable by the action of a bushing bearing.

### TECHNICAL FIELD OF THE INVENTION

The present invention relates to a device for brewing a beverage. In particular, the invention relates to infused tea-based beverages that are brewed in a device having an infusion chamber.

### BACKGROUND TO THE INVENTION

Beverages such as tea and coffee are usually prepared in the home using ground coffee, tea bags or loose-leaf tea. However, the long brewing time required and the mess that is produced are inconvenient. Therefore brewing devices have been devised which provide a convenient, rapid and consumer-friendly way of brewing such beverages.

WO 2007/042485 discloses a machine for making tea, which includes a visible chamber containing brewed tea. The chamber includes a static sprinkler system at the top to remove tea leaves from the wall of the chamber.

WO 2014/006051 discloses a motorized beverage machine which is designed to work with tea. The device has a large visible infusion chamber. Heated water is pumped directly into a capsule containing the tea leaves, which are promptly ejected into the infusion chamber. The brewing of the tea takes place in the infusion chamber. Once complete the tea beverage is discharged from the infusion chamber and the tea leaves are captured by a filter.

As the tea brews, the leaves swell and can become quite sticky. Green teas with their generally larger leaf sizes are particularly prone to sticking. As a result, some tea leaves remain on the surface of the infusion chamber after the brewed tea has dispensed, which are quite difficult to remove.

Additionally a thin film of brewed tea remains on the internal surface of the chamber, which can cause discoloration over time.

However, the consumer has an expectation that the device will remain clean, and therefore there is a need for removal of these deposits.

Thus, the device includes a rinse head, which ejects water to fall down the walls of the infusion chamber, with the intention of rinsing the walls and removing any tea material.

The machine is also designed so that the rinse water is delivered to the dispensed beverage to be consumed by the consumer. This removes the need for separate disposal of the rinse water and ensures an economical use of water and energy in the device. The rinse head includes rinse channels located near the top of the infusion chamber that rotate. The rinse head is rotatable, driven by the reaction force of the rinse water exiting the rinse channels.

However, it has been found that sometimes the rinse was not capable of removing all the tea leaves from the surface of the infusion chamber with the limited quantity of water available.

Thus, improvements in this area are highly desirable.

### BRIEF DESCRIPTION OF THE INVENTION

It has been found that static rinse heads are cheaper to manufacture and can have improved reliability due to the relative absence of moving parts. However it has also been found that a rotating rinse head can provide significantly superior rinsing performance, which can outweigh the advantages of using a static rinse head, particularly when the quantity of water available for rinsing is limited.

However, this alone is insufficient and further improvements on such rotating rinse heads are needed.

In a known type of rinse head, rinse water flows into a central region, whereupon it is redirected outwardly by one or more rinse channels. The rinse head is mounted to be rotatable and thus has an axis of rotation. The central region is typically positioned on the axis of rotation.

A convenient means of inducing rotation is to provide for one or more of the rinse channels to project rinse water with momentum in a direction that provides a moment about the axis of rotation. The reaction force of the projected rinse water will then cause a rotation force around the axis of rotation due to the presence of an equal and opposite moment about the axis of rotation. Upon rotation, the ends of the rinse channels prescribe a circle which is perpendicular to the axis of rotation, termed herein as the rotation circle.

The inventors have found that improvements in rinsing can be achieved if the speed of rotation can be increased and made to be more consistent and reliable.

It is elementary mechanics that the greatest rotational force induced is obtained when the rinse channels are arranged to direct the rinse water to have a momentum which is in a direction which is as close to tangential to the rotation circle as possible. Additionally, the rotational force will be proportional to the distance from the centre of rotation to the ends of the rinse channels, according to the lever rule.

Thus, for example, the rinse channels must direct the rinse water through 90° in the plane of the rotation circle, if they are to redirect the momentum of the rinse water from a direction normal to the axis of rotation to one which is tangential to the rotation circle. It has also been observed that the angle through which the rinse channels redirect the flow of rinse water away from the direction normal to the axis of rotation, termed herein as the redirection angle, has a negative impact on the momentum of the rinse fluid, and so should ideally be kept to a minimum in order to maximize the resulting rinse water velocity leaving the rinse channels.

Thus, one apparent solution to these constraints is to have straight rinse channels projecting outwards normally from the axis of rotation and having a single 90° bend near their ends, in order to provide the tangential rinse water redirection in the most direct manner.

However, surprisingly, the inventors have found that this is not an ideal arrangement, particularly when rinse flow volumes are restricted to a low level.

Thus, in a first aspect, the invention relates to a brewing device, the device comprising; a reservoir for containing a supply of liquid, and a channel providing a flow channel from the reservoir to a rinse head situated in an infusion chamber, wherein the rinse head is mounted to be rotatable, defining an axis of rotation, the rinse head comprising at least one arcuate rinse channel, arranged to project rinse water with momentum in a direction that provides a moment about the axis of rotation, whereby, in use, the moment induces rotation of the rinse head about the axis of rotation and the at least one arcuate rinse channel prescribes a rotation circle.

It has been surprisingly found that arcuate rinse channels provide improved spin speed and reliability of spin. It is believed that the gradual redirection provides a reduced restriction of flow as a result of a more gradual redirection of the rinse water.

Thus this solution is counter-intuitive, as a more gradual application of the redirection angle will inevitably require a greater length of flow channel than for an equivalent flow channel which is straight with a 90° bend at the end, as described above.

Preferably the arcuate rinse channels have a substantially constant radius of curvature. This has been found to provide a greater reliability of flow and a more even and consistent flow, as the rinse water changes direction more gradually in the rinse channel.

Preferably the axis of rotation is substantially vertical in use. This assists with the free rotation of the rinse head.

Since the rinse head rotates it also typically requires a bearing. However, following an investigation, it has been found that the use of a ball bearing can give problems with the rinse head blocking and/or not rotating. In particular, even very small differences in ball bearing size have been found to lead to differences in rinse head rotation speed. In addition, even small levels of scale build up on the ball bearings can cause problems of the rinse head failing to spin properly.

Thus, in a second aspect, the invention relates to a brewing device, the device comprising; a reservoir for containing a supply of liquid, and a channel providing a rinse channel from the reservoir to a rinse head situated in an infusion chamber and comprising a plurality of rinse channels, wherein the rinse head is mounted to be rotatable by the action of a bushing bearing.

It has been found that a bushing reduces or eliminates the blocking tendency and improves the reliability of the rinse head generally, giving more consistent rotation speeds and rinsing efficacy.

A bushing bearing corresponds to an approximately cylindrical insert, upon which the rinse head can rotate.

In a preferred embodiment the flow channel of rinse water flows through the bushing bearing.

In a preferred embodiment, the rinse water also ends up in the dispensed beverage to be consumed by the consumer. This removes the need for separate disposal of the rinse water and ensures an economical use of water and energy in the device. However this does place a constraint on the quantity of water that is available for rinsing. Too much rinse water entering the beverage would reduce the perceived quality. Thus, the quantity of rinse water available is preferably less than 100 ml, more preferably less than 80 ml, most preferably less than 60 ml.

In order to provide sufficient water to provide the rinsing function, however the quantity of rinse water is preferably greater than 30 ml, more preferably greater than 40 ml, most preferably greater than 50 ml.

It has been found that in general the greater the rotational speed the better the rinsing effect for a given volume of rinse water. This is because it has been found that static rinse channels tend to produce rivulets of water on the inside wall of the infusion chamber, which leave areas of the infusion chamber with tea leaves in place. A rotating rinse flow tends to provide a “curtain” of water which falls down the walls to provide more complete coverage of the walls of the infusion chamber, and a greater rotational speed improves the consistency of this curtain.

It has been found that if the rotation speed is too slow then an adequate curtain of water is not produced, whereas if the rotational speed is too great then too much water can be used. In general it has been found that rotation speeds of from 150 to 600 rpm are preferred, more preferably from 250 to 500 rpm, most preferably from 300 to 450 rpm.

In a preferred embodiment the rinse head comprises two to eight rinse channels, more preferably from two to four rinse channels, e.g. two channels.

It has also been found that better rotational consistency and speed of rotation can be achieved when there is a balancing of the forces around the axis of rotation. Thus, preferably the rinse channels are spaced apart with radial symmetry, e.g. three rinse channels would be spaced 120° apart. It is also preferred that the rinse channels are each substantially identical to each other.

In general it has been found to be preferable to obtain a redirected flow which is as close as possible to tangential to the axis of rotation. Thus, in a preferred embodiment the rinse channels provide a redirection angle of greater than 90° and less than 230° in the plane of the rotation circle. More preferably they curve through from 100 to 200°, most preferably from 120 to 180°, e.g. around 150°.

Preferably the rinse channels curve in a plane perpendicular to the axis of rotation.

Preferably the rinse channels have a cross sectional area of from 2 to 8 mm², more preferably from 3 to 6 mm².

It has been found that it is beneficial for rinsing efficacy if the rinse channels end in at least one constriction or nozzle. A smaller nozzle helps to minimize the amount of water used but has a tendency to block prematurely due to scale build-up over time. A larger nozzle gives a larger jet of water and has a much lower tendency to block over time but uses a lot of water to clean the infusion chamber. Thus, preferably the at least one nozzle has a cross-sectional area of from 0.4 to 2.5 mm², more preferably from 0.7 to 1.5 mm², most preferably from 0.75 to 1.2 mm².

Each rinse channel may comprise a plurality of such constrictions or nozzles, which may act to direct the fluid in the same or different directions.

As discussed above, the optimum direction for the rinse channels to provide rotation is tangential to the rotation circle. However, for rinsing purposes a tangential direction may be inappropriate as the shortest distance to the walls of the infusion chamber will usually be in a direction normal to the rotation circle. As discussed above, a jet direction normal to the rotation circle will however provide no rotational momentum.

The inventors have found a surprising way to resolve this apparent technical conflict.

In a preferred embodiment at least one rinse channel ends in at least two nozzles. In this way, one nozzle may be oriented for optimum rinsing, and another nozzle may be oriented for optimum rotational momentum. Furthermore, it has been found that a nozzle, although optimized for rotational momentum may also provide some useful rinsing and vice versa.

Thus in a preferred embodiment, at least one rinse channel has a propulsion nozzle directed to within 20°, preferably within 10° of tangential to the rotation circle and a rinse nozzle directed to within 20°, preferably within 10° of a direction normal to the rotation circle.

It has been furthermore found that the rinse jets' rinsing ability is improved if they are directed “downwards” so as to collide with the wall with a significant vertical momentum which has been found to improve the ability of the jets to dislodge sticky tea leaves on the wall.

It has been found that any downwards angle from horizontal improves rinsing performance. However any downwards angle will inevitably leave an upper region of the wall of the infusion chamber without any rinse water. Thus, preferably the rinse nozzle is directed from 10 to 60° downwards from horizontal, more preferably from 30 to 60°, most preferably greater than 40°, e.g. 50°.

As discussed above, the propulsion nozzle also provides some useful rinsing function. However, the propulsion provided by the propulsion nozzle will be reduced by any downwards angle. However some downwards angle may improve rinsing without having a large impact on propulsion. Thus, preferably the propulsion nozzle is directed from 0 to 30° downwards from horizontal, more preferably from 0 to 20°, e.g. 10°.

As discussed above, it has been found that better rotational consistency and speed of rotation can be achieved when there is a balancing of the forces around the axis of rotation. Thus it is preferred that the arrangement of the nozzles and their directions is substantially the same across all rinse channels.

It has also been found that the material of construction needs to be carefully chosen. The rinse head may be subjected to large temperature cycles as it may be routinely exposed to steam or hot water, in addition the material should be food grade and ideally mouldable and resistant to scale build-up. Given these constraints it has been found that a Nylon™ material works well, such as Zytel FG 151L™.

It has also been found that greater reliability over the longer term can be achieved if the bearing surfaces are polished. This is believed to reduce or prevent the build-up of scale deposits.

In a preferred embodiment the infusion chamber comprises a bottom rim which defines an opening; a capsule holder for receiving a capsule, the capsule holder comprising a sidewall having an upper rim, a filter and an openable and closable passage on the opposite side of the filter from the upper rim; means for moving the capsule holder and/or the infusion chamber so that the upper rim of the capsule holder is connected to the bottom rim of the infusion chamber; means for introducing liquid into the capsule so that the liquid and tea material can mix and flow into the infusion chamber so as to brew a beverage; and a valve for opening the passage in the capsule holder to allow the beverage to flow from the infusion chamber through the filter and out through the passage.

The infusion chamber is preferably transparent, e.g. made of glass or transparent plastic so that the user can see the motion of the tea material (such as tea leaves) whilst the beverage is brewing. Such an infusion chamber benefits from the invention, because it is all the more important to retain a clean interior walls of the infusion chamber.

### DETAILED DESCRIPTION OF THE INVENTION

As used herein the term “tea material” refers to tea plant material, herb plant material or a mixture thereof. For the avoidance of doubt, the term “tea material” does not include coffee material. The term “tea plant material” refers to leaf, bud and/or stem material from Camellia sinensis var. sinensis and/or Camellia sinensis var. assamica. The tea plant material may be substantially fermented (i.e. black tea), partially fermented (i.e. oolong tea) or substantially unfermented (i.e. green tea or white tea). It may also be a blend of one or more of the aforementioned tea plant materials. Other ingredients which are commonly used to flavour leaf tea products may also be combined with the tea plant material (e.g. bergamot, citrus peel and the like). The term “herb plant material” refers to material which is commonly used as a precursor for herbal infusions. Preferably the herb plant material is selected from chamomile, cinnamon, elderflower, ginger, hibiscus, jasmine, lavender, lemongrass, mint, rooibos (obtained from Aspalathus linearis), rosehip, vanilla and verbena. The tea material may additionally comprise fruit pieces (e.g. apple, blackcurrant, mango, peach, pineapple, raspberry, strawberry etc).

Preferably the tea material is dried and has a moisture content of less than 30 wt %, more preferably less than 20 wt % and most preferably from 0.1 to 10 wt %.

Preferably the tea material particles have a size (i.e. longest diameter) of from about 2 to about 10 mm, preferably 3 to 7 mm.

The term “beverage” refers to a substantially aqueous drinkable composition which is suitable for human consumption. Preferably the beverage comprises at least 85% water by weight of the beverage, more preferably at least 90% and most preferably from 95 to 99.9%. Preferably the beverage comprises from 0.04 to 3%, more preferably from 0.06 to 2%, most preferably from 0.1 to 1% by weight tea solids.

The term “brewing” refers to the addition of a liquid, particularly hot water, to tea material, so that steeping or soaking the tea material in the liquid releases soluble substances into the liquid (e.g. flavour and/or aroma molecules) thereby to form a beverage. Brewing may be carried out at any temperature, but preferably in the range of 80 to 95° C.

The term “infusion chamber” means a vessel in which infusion of tea material takes place, and which is large enough both to allow the tea material to move around in the liquid during infusion, and also to contain a substantial part (i.e. at least 50%) of the volume of the final beverage. The term “infusion chamber” therefore does not refer to capsules inside which brewing takes place, as is typically the case in coffee machines.

The term “capsule” refers to a rigid or semi-rigid container in which tea material is or may be packaged, for example a capsule, cartridge, pod, or the like.

The present invention will now be described with reference to the figures, wherein:

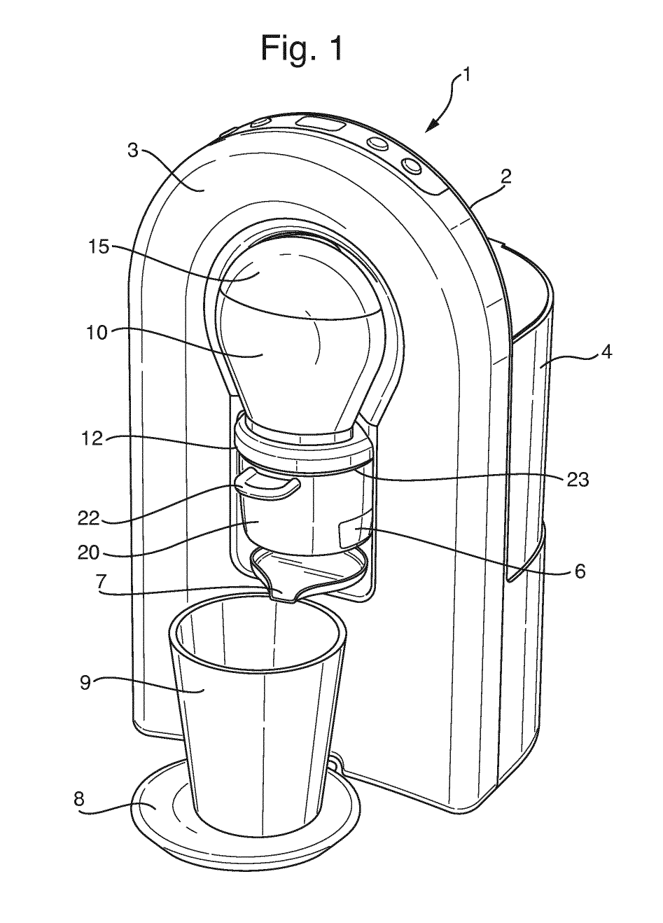

FIG. 1 shows a brewing device according to the invention.

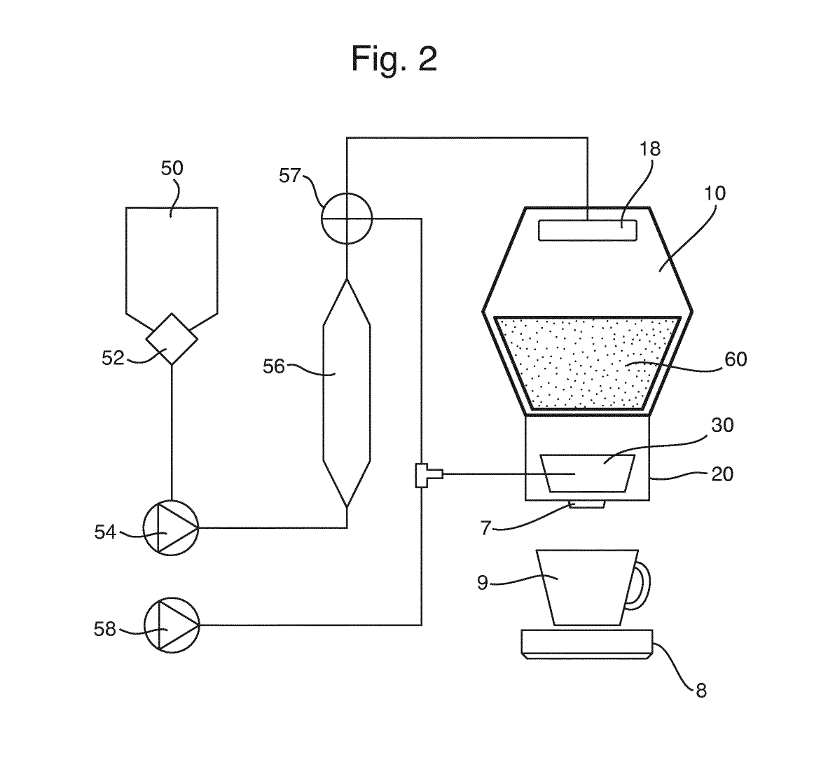

FIG. 2 is a schematic diagram showing the main functional components of the device.

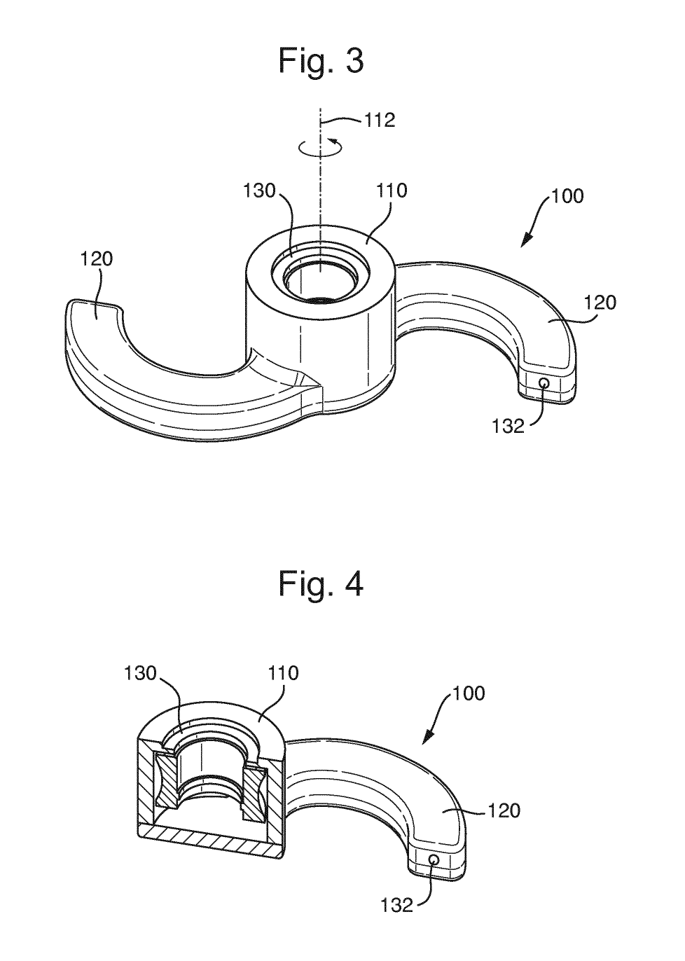

FIG. 3 is a perspective view of a rinse head according to the present invention.

FIG. 4 is a sectional view of the rinse head shown in FIG. 3.

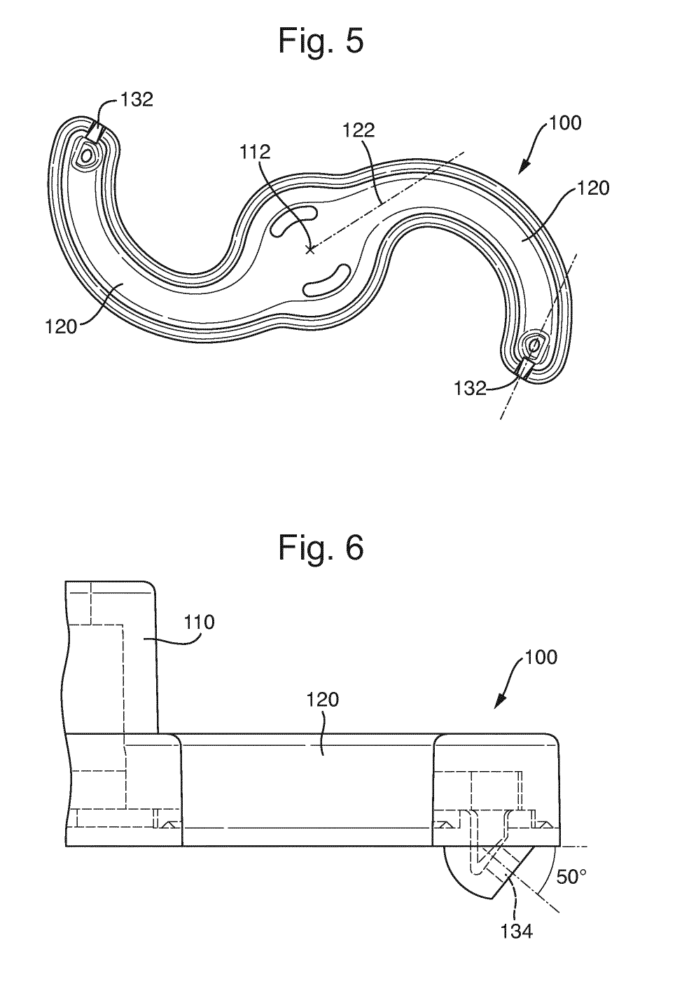

FIG. 5 is a sectional plan view of the rinse head shown in FIG. 3.

FIG. 6 is a front sectional view through the rinse head shown in FIG. 3.

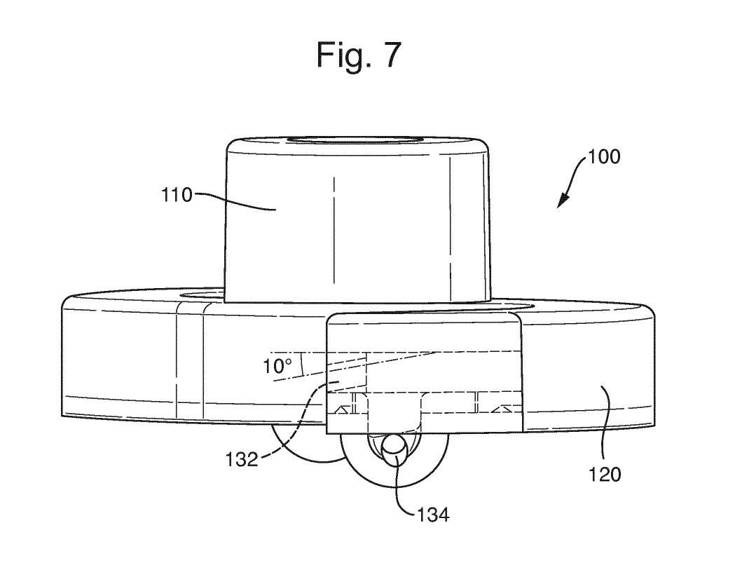

FIG. 7 is a side sectional view through the rinse head shown in FIG. 3.

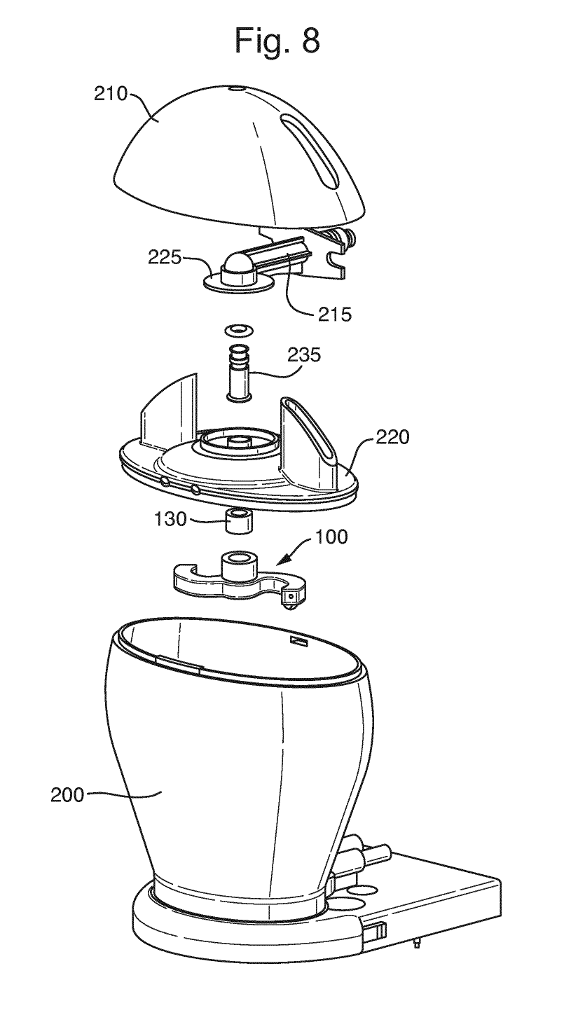

FIG. 8 is an exploded diagram showing how the rinse head fits with an infusion chamber.

FIG. 1 shows one non-limiting embodiment of a brewing device according to the invention. The device 1 has a casing 2 with a front side 3 and a rear side 4. An infusion chamber 10 and a capsule holder 20 are located at the front side of the device. The infusion chamber 10 has a bottom rim 12 which defines an opening in its lower side. The infusion chamber may have an opening in its top side which is covered with a removable lid 15, or it may be constructed as a vessel without an opening in its top side. The capsule holder 20 is designed to receive a capsule. It is located in a support 6 and preferably has a handle 22. The capsule holder is preferably substantially circular when viewed from above, which provides for easy cleaning since there are no corners in which tea leaves could become trapped.

In FIG. 1, the capsule holder 20 is shown in position for brewing, i.e. so that the upper rim 23 of the capsule holder is in water-tight contact with the bottom rim 12 of the infusion chamber 10. The infusion chamber 10 is supported and held in place by a manifold (not shown). A water reservoir, heater, and pump (not shown) are located inside the rear 4 of the casing. At the bottom of the front side 3 of the casing there is a tray 8 on which a cup 9 is placed when the beverage is dispensed. A dispensing spout 7 is positioned beneath the capsule holder.

FIG. 2 is a schematic diagram showing the main functional components of the device. Water from the reservoir 50 is fed to the infusion chamber 10 via a water filter 52, a water pump 54, a heater 56 and a valve 57. The heater is preferably a flow-through heater. The valve 57 controls the route the water takes between the heater 56 and the infusion chamber 10. For example, the water may firstly be pumped to the infusion chamber 10 via the capsule 30 in order to brew a beverage 60. Subsequently, the valve 57 can re-direct the water such that it enters the infusion chamber 10 via a rinse head 18 in order to rinse and/or clean the infusion chamber 10. There may also be an air pump 58 which can pump air to the infusion chamber, for example via the capsule 30 which is located in the capsule holder 20, or via the capsule holder itself. The spout 7, cup 9 and tray 8 are located beneath the capsule holder 20.

Preferably the infusion chamber 10 is made of transparent material such as glass, or transparent plastic, so that the user can see the motion of the tea material (such as tea leaves) whilst the beverage is brewing. Most preferably, the infusion chamber is made of Tritan™ copolyester because this material is transparent and has been found to have good resistance to staining. Air may be pumped into the capsule holder 20 (e.g. via the capsule) or directly into the infusion chamber 10 to create bubbles in the water and thereby agitate the tea material. This not only enhances the visual appearance, but also aids infusion and helps to prevent the tea material from sticking to the sides of the infusion chamber. Moreover, the introduction of air releases aroma which can optionally be vented via a tube, which for example, has an outlet near to the dispensing spout or near the top of the infusion chamber, thereby providing the user with the aroma of tea during brewing. The brewing time, which typically ranges from 10 to 120 seconds, is preferably set by user input and/or information read from the capsule.

Once brewing has taken place for the required time, a drain valve located in the base of the capsule holder 20 is opened, allowing the beverage to drain from the infusion chamber. Preferably the opening of the drain valve is controlled automatically by the machine. The beverage flows from the infusion chamber 10 through a filter located in the capsule holder below the capsule, through a passage, and finally into a cup 9 which the user has already placed onto the tray 8. Tea material is prevented from entering the cup 9 by the filter.

Optionally, there may be a dispensing spout 7 positioned beneath the capsule holder as shown in FIG. 1, so that the beverage is dispensed through the drain valve and out through the spout. Thus, instead of being dispensed vertically downwards into the receptacle, the beverage follows an arc, similar to that of tea poured from the spout of a tea pot. This enhances the “theatre” provided by the machine for the user, and also emphasizes the “tea-ness” of the beverage, as distinct from coffee making machines.

After the beverage has been dispensed, the spent tea material may be rinsed from the wall of the brew chamber with further hot water. Preferably the rinsing water is introduced through rotating rinse jets 18 located near the top of the infusion chamber. Better rinsing is achieved by rotating rinse jets than static ones. In a preferred embodiment, rinsing takes place immediately after the beverage has been dispensed, and the rinse water is also dispensed into the receptacle and becomes part of the beverage. This removes the need for separate disposal of the rinse water. In this case, the rinse water provides around 15-30% of the total volume of the beverage. The machine is capable of providing beverage volumes of 200 or 250 ml, and this includes the rinse water at volumes of 60 and 90 ml respectively.

FIGS. 3 and 4 show a rinse head 100 according to the present invention. The rinse head comprises a cylindrical main body 110, to which is attached two arcuate rinse channels 120. The main body 110 also comprises a bushing 130 which acts as a bearing to allow rotation of the main body 110.

The rinse head 100 has a vertical axis of rotation 112 and the rinse channels rotate in a plane perpendicular to the axis of rotation, prescribing a rotation circle with a radius of approximately 2 cm.

As can be seen the rinse channels 120 have a substantially constant radius of curvature.

The rinse channels 120 terminate in a narrowing propulsion nozzle 132. The narrowing of the nozzle with respect to the diameter of the rinse channel results in an acceleration of the rinse water as it passes through the propulsion nozzle.

As can be seen in FIG. 5, the initial direction 122 of the rinse channel is normal to the axis of rotation 112. The arcuate nature of the rinse channel 120 results in a redirection angle of approximately 150°, to result in the propulsion nozzle 132 being directed to be essentially tangential to the rotation circle.

FIG. 6 shows a section through the rinse head 100 showing a rinse nozzle 134 not shown in the previous figures. It can be seen that the rinse nozzle 134 directs rinse water in a direction normal to the axis of rotation 112 but also angled downwards by 50°. Thus, this rinse nozzle does not provide any propulsion because the momentum of the water exiting has a vector which passes through the axis of rotation 112. However its position is instead optimised for rinsing. The angle downwards provides additional vertically downwards momentum which assists in the rinse water's ability to remove tea leaves form the wall of the infusion chamber.

FIG. 7 also reveals a further detail regarding the orientation of propulsion nozzle 132. As mentioned above, propulsion nozzle 132 is oriented to be tangential to the rotation circle. However it can also be seen that propulsion nozzle 132 is also directed downwards by 10°. This downwards direction reduces the propulsion momentum by a negligible amount. However the downwards angle helps significantly with providing downwards vertical momentum to assist the propulsion jet to also provide a useful rinsing function.

Acting together, the propulsion nozzle 132 and the rinsing nozzle 134 provide a combination of propulsion and rinsing which would not be possible from a single nozzle given the limited quantity of water available, as discussed above.

FIG. 8 shows an infusion chamber 200 and an outer cap 210 and an inner cap 220. The outer cap 200 contains a portion of a flow channel 215 which terminates in a rinse head connector 225 which connects to a rinse head mount 235 which carries the flow of rinse water and connects to the rinse head 100 through inner cap 220.

As can be seen, the rinse head 100 is mounted at the top of the infusion chamber with a vertical axis of rotation. In use water is ejected from orifices 132, which causes the rinse head to spin on bushing bearing 130. Water hits the sides of the inner wall of the infusion chamber 200 and coats the wall in a stream of rinse water as it spins. This causes a curtain of water to fall down the inner wall of the infusion chamber which removes any tea material present and also rinses away any beverage material from the walls.

The various features of the embodiments of the present invention referred to in individual sections above apply, as appropriate, to other sections mutatis mutandis. Consequently features specified in one section may be combined with features specified in other sections as appropriate. Various modifications of the described modes for carrying out the invention which are apparent to those skilled in the relevant fields are intended to be within the scope of the following claims.

1. A brewing device comprising:
a reservoir for containing a supply of liquid; and
a channel providing a flow channel from the reservoir to a rinse head situated in an infusion chamber;
wherein the rinse head is mounted to be rotatable and defining an axis of rotation, the rinse head comprising at least one arcuate rinse channel arranged to project rinse water with momentum in a direction that provides a moment about the axis of rotation; and
whereby, in use, the moment induces rotation of the rinse head about the axis of rotation and the at least one arcuate rinse channel prescribes a rotation circle.

2. The brewing device of claim 1,
wherein the rinse head is mounted to be rotatable by the action of a bushing bearing.

3. (canceled)

4. The brewing device of claim 1, wherein the rinse head is adapted so that the rinse water is delivered to a dispensed beverage to be consumed by a consumer.

5. The brewing device of claim 1, wherein a quantity of the rinse water available to the rinse head for being projected therefrom is less than 100 ml.

6. The brewing device of claim 1, wherein a quantity of rinse water available to the rinse head for being projected therefrom is greater than 30 ml.

7. The brewing device of claim 1, wherein the axis of rotation is substantially vertical in use.

8. The brewing device of claim 1, wherein the rinse head rotates in use at a rotational speed of between 150 to 600 rpm, inclusive.

9. The brewing device of claim 1, wherein the rinse head comprises two to eight rinse channels, inclusive.

10. The brewing device of claim 1, wherein the at least one rinse channel has a substantially constant radius of curvature.

11. The brewing device of claim 1, wherein the at least one rinse channel provides a redirection angle of greater than 90° and less than 230° around the axis of rotation, inclusive.

12. The brewing device of claim 1, wherein the at least one rinse channel curves in a plane perpendicular to the axis of rotation.

13. The brewing device of claim 1, wherein at least one of the at least one rinse channel ends in at least one nozzle.

14. The brewing device of to claim 13, wherein the at least one nozzle has a cross-sectional area of from 0.4 to 2.5 mm², inclusive.

15. The brewing device of claim 13, wherein at least one of the at least one rinse channel ends in at least two nozzles.

16. The brewing device of claim 15, wherein at least one of the at least one rinse channel has a propulsion nozzle directed to within 20°, of tangential to the rotation circle and a rinse nozzle directed to within 20°, of a direction normal to the rotation circle.

17. The brewing device of claim 16, wherein the rinse nozzle is directed from 10 to 60°, inclusive, downwards from horizontal.

18. The brewing device of claim 16, wherein the propulsion nozzle is directed from 0 to 30°, inclusive, downwards from horizontal.

19. A brewing device comprising:
a reservoir for containing a supply of liquid; and
a channel providing a flow channel from the reservoir to a rinse head situated in an infusion chamber and comprising a plurality of rinse channels;
wherein the rinse head is mounted to be rotatable by the action of a bushing bearing.

20. The brewing device of claim 19, wherein at least one of the plurality of rinse channels ends in at least one nozzle.

21. The brewing device of claim 19, wherein at least one of the plurality of rinse channels curves in a plane perpendicular to an axis of rotation about which the rinse head is rotatable.
